(19) United States
(12) Patent Application Publication
(10) Pub. No.: US 2025/0369703 A1
(43) Pub. Date: Dec. 4, 2025

(54) A DRAIN SYSTEM AND A SHOWER OR SHOWER CABIN

(71) Applicant: Enduce AB, UMEÅ (SE)

(72) Inventors: Henrik Hagman, UMEÅ (SE); Gustav Svenson, UMEÅ (SE)

(73) Assignee: Enduce AB, UMEÅ (SE)

(21) Appl. No.: 18/875,922

(22) PCT Filed: Jun. 26, 2023
(86) PCT No.: PCT/EP2023/067335

§ 371 Date: Dec. 17, 2024

(30) Foreign Application Priority Data
Jul. 1, 2022 (SE) 2250830-3

(51) Int. Cl. F28D 21/00; E03C 1/00; E03C 1/22

(52) U.S. Cl. CPC F28D 21/0012; E03C 1/22; E03C 2001/005

(57) ABSTRACT

A drain system for recovering thermal energy from a flow of shower or faucet greywater. The drain system comprises: a drain inlet for receiving greywater; a heat exchanger configured to heat a flow of incoming cold water with the greywater flowing from a grey water inlet to a grey water outlet; and a water level control pipe portion arranged downstream of the grey water outlet. The drain system further comprises a downcomer arranged downstream of the water level control pipe portion. The downcomer comprises a contraction for increasing the flowrate of greywater from the grey water inlet to the grey water outlet.

### FIELD OF THE INVENTION

The present invention relates to drain systems for recovering thermal energy from a flow of greywater. The present invention also relates to showers or shower cabins comprising such drain systems.

### BACKGROUND OF THE INVENTION

A shower typically comprises a shower head fluidly connected to a shower mixer configured to mix hot water from a hot water supply and cold water from a cold water supply. The hot water supply may e.g. be water heated by a domestic boiler (using a combustible fuel, electricity, district heating, or a heat pump). Thus, showers are energy intensive units, consuming a lot of energy to heat the hot water used for showering.

Devices which recover heat from the shower greywater (i.e. the wastewater discharged from a shower floor into a shower drain system) are known from the prior art, e.g. from GB2232749, U.S. Pat. No. 4,619,311, GB2052698 and DE29615555. Such devices are typically installed in the shower drain system to recover heat from the shower greywater, for example from a shower tray, using a plate heat exchanger with a high thermal efficiency. Such drain systems may be referred to as heat recovering drain system. However, since the heat exchanger, and the shower drain system, typically are installed into the floor of the shower or shower tray associated with certain space requirements, adaptation of the size of the drain system is of great importance. Thus, at least for some reasons, the size of the heat exchanger and the associated equipment should be small. However, when keeping the size of the heat exchanger and the associated equipment down, the capacity of the heat recovering drain system is reduced.

In other words, there is a balance between the size of the drain system and the flowrate capacity and heat recovery performance of the drain system, were both the flowrate capacity and heat recovery performance are limited by the size of the system. Thus, there is a need in the industry for an improved drain system.

### SUMMARY

An object of the invention is to overcome the above problems, and to provide a drain system for recovering thermal energy from a flow of shower or faucet greywater which is improved compared to prior art solutions. The drain system comprises a heat exchanger configured to recover thermal energy from the greywater and a configuration enabling increased flowrate of greywater through the heat exchanger. In particular, the increased flowrate of greywater is achieved by the combination of a water level control pipe portion and downcomer arranged downstream of the heat exchanger. The increased flowrate may e.g. refer to an increased overall, or average, flowrate in the drain system. Hereby, the flowrate of greywater through the heat exchanger can be increased while also a satisfactory wetting of the heat exchanger is maintained. Thus, the thermal energy recovery efficiency of the system may be kept maximized at the same time as the flow capacity is increased and the fouling rate is limited. Without a satisfactory wetting of the heat exchanger, portions of the heat exchanger will become cooler than the wetted portions, resulting in increased fouling on the cooler portions of the heat exchanger. Moreover, the drain system of the present invention is relatively simple, cost efficient and user-friendly. This, and other objects, which will become apparent in the following, are accomplished by means of a drain system, and a shower or shower cabin comprising such drain system.

According to at least a first aspect of the present invention, a drain system for recovering thermal energy from a flow of shower or faucet greywater is provided. The system comprises:
a drain inlet for receiving greywater,
a heat exchanger arranged downstream of the drain inlet and comprising a grey water inlet and grey water outlet, the heat exchanger being configured to heat a flow of incoming cold water with the greywater flowing from the grey water inlet to the grey water outlet,
a water level control pipe portion arranged downstream of the grey water outlet, wherein
the drain system further comprises a downcomer arranged downstream of the water level control pipe portion and comprising a contraction for increasing the flowrate of greywater from the grey water inlet to the grey water outlet.

Hereby, an improved drain system is provided including a wetting level control of the heat exchanger, while increasing the flowrate of greywater from the grey water inlet to the grey water outlet by means of the downcomer. By providing a water level control pipe portion and a downcomer comprising said contraction and being arranged downstream of the grey water outlet, a combined effect of controlling the wetting level of the heat exchanger, typically ensuring that at least a majority of the heat exchanging surface in the heat exchanger is wetted, and increasing the flowrate of greywater through the heat exchanger is achieved. Thus, other types of fluid flow increasing means, e.g. a pump or compressor, can be avoided. The drain inlet, the grey water inlet, grey water outlet, the water level control pipe portion and the downcomer are in fluid communication with each other, typically in a gas-tight manner between the drain inlet and downstream the downcomer. Thus, during use of the drain system, greywater flows from the drain inlet, further to the heat exchanger and the grey water inlet, through the heat exchanger to the grey water outlet, further to the water level control pipe portion and the downcomer and the contraction. Thereafter, the greywater is typically discharged to a sewer or the like. Thus, the water level control pipe portion and the downcomer are typically subsequently arranged downstream of the grey water outlet. Moreover, the heat exchanger is thus adapted for a continuous flow of greywater, from the grey water inlet to the grey water outlet. Thus, during use, the contraction increases and stabilizes the flow of greywater through the heat recovery drain system including an increased flowrate from the grey water inlet to the grey water outlet of the heat exchanger. The contraction prevents, or at least reduces, inflow of air into the system, and into the downcomer, thereby improving and stabilizing the flow of greywater through the drain system.

It should be understood that the water level control pipe portion is arranged to control the wetting level of the heat exchanger. The water level control pipe portion may e.g. be arranged to achieve a complete wetting of the heat exchanger. Thus, the water level control pipe portion may be referred to as a wetting level control pipe portion. In other words, the water level control pipe portion may be referred to as a pipe portion arranged downstream of the grey water outlet, the pipe portion being arranged to control the water level, or wetting level, of the heat exchanger. Thus, the drain system may comprise a downstream pipe arranged to receive the greywater discharged from the grey water outlet, wherein the downstream pipe comprises a pipe portion being arranged to control the water level, or wetting level, of the heat exchanger. The water level control pipe portion may be arranged to ensure a continuous flow of greywater through the heat exchanger, while maintaining an at least minimum wetting level, such as e.g. a complete wetting of the heat exchanger. In other words, the heat exchanger and the water level control pipe portion are arranged to, in use, enable the heat exchanger to be continuously wetted, i.e. maintaining an at least minimum wetting level, such as e.g. a complete wetting of the heat exchanger during use.

It should be understood that the downcomer is arranged to act as a siphon to the heat exchanger and increase the flowrate of greywater. Thus, during use, the downcomer, or siphon pipe portion, results in an increase of the height of the hydraulic pillar, resulting in an increased driving pressure of the greywater, enabling a higher flowrate. The downcomer may be referred to as a siphon pipe portion. The downcomer is to be understood as a pipe, or pipe portion, arranged to conduct, or guide, the greywater downwards. Thus, with reference to the previously described downstream pipe, the downstream pipe may comprise a pipe portion being arranged to conduct, or guide, the greywater downwards, wherein such pipe portion is arranged downstream of the water level control pipe portion and comprises the contraction.

According to at least one example embodiment, the water level control pipe portion has a water flow section with a lowest point arranged vertically above at least a portion of the grey water outlet.

Hereby, the water level control pipe portion ensures that all heat exchanging surfaces within the heat exchanger and located vertically below said portion of the grey water outlet is wetted. Hereby, gas or air in the heat exchanger can be reduced, or even avoided. Thus, the flow of greywater through the heat exchanger can be kept uninterrupted, the wetting of the heat exchanging surfaces can be kept high, or even complete, and the efficiency of the heat exchanger kept high. Thus, the water level control pipe portion acts as a wetting level control portion arranged at a height corresponding to the wetting level of the heat exchanger. Thus, the water level control pipe portion may be referred to as a wetting level control pipe portion. The water level control pipe portion thus ensures that the wetting level, or water level, within the heat exchanger is kept at the maximum (or rated) level. The lowest point may be referred to as the vertically lowest point of the water flow section. The water flow section having the lowest point arranged vertically above the grey water outlet, is typically a horizontally arranged pipe portion of the water level control pipe portion. According to at least one example embodiment, such water flow section is arranged at a height vertically above the grey water outlet, or at least partly above the grey water outlet. The flow-through area of the grey water outlet is typically defined by its radial cross section. The radial cross section typically extends in the vertical direction as the grey water outlet is configured to discharge the greywater mainly in the horizontal direction.

According to at least one example embodiment, the lowest point of water flow section of the water level control pipe portion is arranged vertically above the highest point of the grey water outlet, or the radial cross section thereof. According to at least one example embodiment, the lowest point of water flow section of the water level control pipe portion is arranged vertically above a centre axis of the grey water outlet. According to at least one example embodiment, the lowest point of water flow section of the water level control pipe portion is arranged vertically above the lowest point of the grey water outlet, or the radial cross section thereof.

According to at least one alternative example embodiment, the water flow section of the water level control pipe portion is arranged vertically in the same vertical level, or vertically above, the grey water outlet.

According to at least one example embodiment, the drain system further comprises a water trap arranged downstream of the grey water outlet, wherein the water level control pipe portion is comprised in the water trap or is arranged downstream of the water trap.

Thus, the drain system may comprise a water trap arranged downstream of the grey water outlet. The water trap may e.g. end into the water level control pipe portion, or the water level control pipe portion may be comprised in the water trap. Thus, the water level control pipe portion need not to be comprised in the water trap. The water trap may e.g. be a U-shaped pipe portion, typically designed to trap liquid or gas to prevent unwanted flow, e.g. sewer gases from flowing upstream. In an alternative example embodiment, the drain system comprises a water trap arranged downstream of the water level control pipe portion.

According to at least one example embodiment, the downcomer is arranged directly downstream of the water trap. For example, the water trap ends into the downcomer. According to at least one alternative example embodiment, the downcomer forms a part of the water trap, i.e. is comprised in the water trap.

According to at least one example embodiment, the water level control pipe portion is connected to the downcomer by means of a pipe bend, e.g. a 90 degrees bend.

According to at least one example embodiment, the water level control pipe portion is a horizontally arranged pipe portion, or is comprised in a pipe bend.

Hereby, the wetting level in the heat exchanger can be controlled in an efficient manner. For example, the horizontally arranged pipe portion, or pipe bend, of the water level control pipe portion comprises the previously mentioned water flow section with the lowest point arranged vertically above the grey water outlet.

According to at least one example embodiment, the radial cross section of the water level control pipe portion is non-circular.

Hereby, the previously mentioned water flow section with the lowest point can be adapted. For example, by having a non-circular radial cross section of the water level control pipe portion which is oval and defined by having a larger central horizontal axis than a central vertical axis, the lowest point of the water flow section can be arranged vertically higher, compared to if a corresponding circular radial cross section would have been used.

According to at least one example embodiment, the downcomer is a vertically arranged pipe portion.

Hereby, the downcomer can efficiently increase the flowrate of greywater.

According to at least one example embodiment, the contraction in the downcomer is tapering.

Hereby, during use, greywater will be guided to the center portion of the downcomer, thereby reducing the risk of forming air/gas pockets, or air/gas channels along the internal wall portions of the downcomer. In other words, the water in the downcomer is forced against the wall and center of the tapering contraction, resulting in an improved water pillar, increasing the stability and performance of the flow of greywater in the downcomer. Hereby, the overall flowrate of greywater in the drain system may be increased. Typically, the downcomer is tapering in the downstream direction. Thus, according to at least one example embodiment, the contraction in the downcomer is tapering in a downstream direction. In other words, the fluid flow cross section area in the downcomer decreases in the downstream direction. Stated differently, at a first position of the downcomer, the fluid flow cross sectional area (such as a radial cross-sectional area) has a first value, and at a second position of the downcomer arranged distant of the first position, or downstream of the first position, the fluid flow cross sectional area (such as a radial cross sectional area) has a second value being lower than said first value.

According to at least one example embodiment, the downcomer is a vertically arranged pipe portion, wherein the contraction in the downcomer is tapering, typically in the downstream direction. Thus, with reference to the previously mentioned first and second position of the downcomer, the second position is arranged below, such as vertically below, the first position.

According to at least one example embodiment, the contraction in the downcomer is conically tapering.

According to at least one example embodiment, the drain system further comprises a drain manifold having a first manifold inlet arranged downstream of the downcomer, and a manifold outlet arranged to supply any received grey water to a drain outlet.

Hereby, an efficient structure for guiding the greywater from the downcomer to the drain outlet is provided. Moreover, the drain manifold provides the possibility of designing the downcomer (and other upstream components) independently of the drain outlet. For example, the dimensions of the downcomer may differ from that of a drain outlet pipe connected to the manifold outlet. Thus, standard dimensions may be used for the drain outlet pipe chosen independently of the downcomer. The drain outlet pipe may e.g. have a diameter of between 50 mm and 110 mm, preferably 75 mm. The downcomer may e.g. have a diameter of between 15 mm and 70 mm. The drain manifold provides an increased stability, or fixity, of the drain system, as the downcomer (and other upstream components), as well as any drain outlet pipe, is/are fixated in position by the drain manifold.

According to at least one example embodiment, the downcomer ends in the first manifold inlet.

That is, the first manifold inlet is arranged directly downstream of the downcomer. According to at least one example embodiment, the downcomer is integrated into the drain manifold. Hereby, structure providing an efficient connectability to the heat exchanger and any drain outlet pipe is provided.

According to at least one example embodiment, the drain manifold comprises a second manifold inlet, and the drain system further comprises a by-pass conduit arranged to supply greywater to the second manifold inlet by by-passing the heat exchanger.

Hereby, greywater can be passed to the drain manifold and the drain outlet without passing through the heat exchanger and related portions of the drain system. Thus, in case of flooding, or in order to handle a flow of greywater exceeding the capacity of the heat exchanger, the drain system is configured to guide the greywater to the drain manifold and the drain outlet via the by-pass conduit. The drain manifold may thus have a multi-purpose function of providing a structure capable of collecting various greywater flows and guiding them to a common drain outlet. Moreover, as previously mentioned, the drain manifold may provide an increased stability, or fixity, of the drain system, as the downcomer (and other upstream components), the by-pass conduit, as well as any drain outlet pipe, is/are fixated in position by the drain manifold.

According to at least one example embodiment, the downcomer is a first downcomer, and the drain system comprises a second downcomer arranged in the by-pass conduit and comprising a contraction for increasing the flowrate of greywater in the by-pass conduit.

Hereby, the flowrate of greywater in the by-pass conduit may be increased in a corresponding manner as described with reference to the first downcomer. The embodiments mentioned with regards to the first downcomer are applicable to the second downcomer as well, even though the first and second downcomers may (but do no need to) be designed differently. For example, the second downcomer is a vertically arranged pipe portion, and/or the contraction is a tapering contraction (typically a tapering contraction in the downstream direction, and/or is conically tapering).

According to at least one example embodiment, the drain manifold comprises a third manifold inlet arranged to supply greywater leaked from the heat exchanger, or any pipe portions or connections to the heat exchanger, to the drain manifold and further to the drain outlet.

According to at least one example embodiment, the drain manifold, the second manifold inlet, and/or the third manifold inlet comprises a water trap, or odor trap. For example, in the example of an odor trap, the odor trap may be a membrane trap. For example, the odor trap may comprise a membrane, such as a silicon membrane, arranged to be closed when no greywater flows through the corresponding structure (i.e. the drain manifold, the second manifold inlet, and/or the third manifold inlet) to thereby prevent odors upstream in the drain system, and arranged to open upon receiving a greywater flow through the corresponding structure. The odor trap may be referred to as a mechanical odor trap.

According to at least one example embodiment, the heat exchanger is a plate heat exchanger.

A plate heat exchanger typically provides an efficient heat transfer between the greywater and the incoming cold water. For example, the grey water outlet of the plate heat exchanger is arranged in an upper half of the heat exchanger. According to at least one example embodiment, the heat exchanger is arranged for continuous heat exchange between the greywater and the incoming cold water.

According to a second aspect of the present invention, a shower or shower cabin is provided. The shower or shower cabin comprises:
a shower arrangement having a shower mixer configured to mix hot water from a hot water supply and pre-heated cold water from a cold water supply, and a shower head fluidly connected to the shower mixer for supplying shower water;
a drain system according to the first aspect of the invention.

Effects and features of the second aspect of the invention are largely analogous to those described above in connection with the first aspect of the invention. Embodiments mentioned in relation to the first aspect of the invention are largely compatible with the second aspect of the invention, of which some are exemplified below.

The shower or shower cabin may comprise a shower floor or a shower tray, or alternatively be replaced with a shower tray (i.e. a shower cabin without the enclosing walls). The drain system of the first aspect of the invention may e.g. be integrated into such shower floor or shower tray.

According to at least one example embodiment, the heat exchanger of the drain system is configured to heat a flow of incoming cold water with the greywater flowing from the grey water inlet to the grey water outlet, to provide the cold water as the pre-heated cold water of the shower arrangement.

Thus, the drain system may be arranged and configured to pre-heat the cold water from a cold water supply prior to that the cold water (or pre-heated cold water) is supplied to the shower mixer. The cold water may e.g. be tap water. Thus, the drain system may be connectable to a tap water supply.

According to a third aspect of the present invention, a drain system for recovering thermal energy from a flow of shower or faucet greywater is provided. The system comprises:
a drain inlet for receiving greywater,
a heat exchanger arranged downstream of the drain inlet and comprising a grey water inlet and grey water outlet, the heat exchanger being configured to heat a flow of incoming cold water with the greywater flowing from the grey water inlet to the grey water outlet,
a drain manifold having a first manifold inlet arranged downstream of the heat exchanger, and a manifold outlet arranged to supply any received grey water to a drain outlet.

Wherein the drain manifold comprises a second manifold inlet, and the drain system further comprises a by-pass conduit arranged to supply greywater to the second manifold inlet by by-passing the heat exchanger.

Hereby, greywater can be passed to the drain manifold and the drain outlet without passing through the heat exchanger and related portions of the drain system. Thus, in case of flooding, or in order to handle a flow of greywater exceeding the capacity of the heat exchanger, the drain system is configured to guide the greywater to the drain manifold and the drain outlet via the by-pass conduit. The drain system may comprise a downcomer, as the second downcomer described with reference to the first aspect of the invention, arranged in the by-pass conduit and comprising a contraction for increasing the flowrate of greywater in the by-pass conduit. Hereby, the flowrate of greywater in the by-pass conduit may be increased in a corresponding manner as described with reference to the first downcomer described with reference to the first aspect of the invention. The embodiments mentioned with regards to the first downcomer of the first aspect of the invention are applicable to the downcomer in the by-pass conduit. For example, the downcomer in the by-pass conduit may be a vertically arranged pipe portion, and/or the contraction may be a tapering contraction (typically a tapering contraction in the downstream direction, and/or is conically tapering).

Applicable to both the first, second and third aspects of the invention, it should be noted that the heat exchanger of the drain system may be configured to preheat incoming cold water to a mixer of the shower or faucet. However, according to at least one example embodiment, the heat exchanger of the drain system is configured to preheat incoming cold water in part, or completely, to a water heater, such an externally arranged water heater (i.e. externally arranged relatively to the drain system), or an instant heater. Thus, the preheated cold water may be partly or completely routed to a water heater, resulting in an increased flow of cold water through the heat exchanger and thereby increasing the heat recovery from the grey water compared to if the cold water through the heat exchanger was only supplied to the shower mixer. The heat exchanger is typically arranged to discharge the greywater downstream to e.g. a sewer. As mentioned with regards to the first aspect of the invention, the heat exchanger is preferably a plate heat exchanger.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present inventive concept will now be described in more detail, with reference to the appended drawings showing an example embodiment of the inventive concept, wherein:

FIG. 1 schematically illustrates a shower or shower cabin comprising a drain system for recovering thermal energy from a flow of greywater, in accordance with at least some example embodiments of the invention;

FIG. 2 illustrates the drain system of FIG. 1 in more detail, and according to at least one example embodiment of the invention,

FIG. 3 illustrates details of the drain system of FIG. 2, and according to at least one example embodiment of the invention,

FIG. 4 illustrates further details of the drain system of FIG. 3, according to at least one example embodiment of the invention, and

FIG. 5 illustrates a drain system according to at least one example embodiment of the invention.

### DETAILED DESCRIPTION OF EXAMPLE EMBODIMENTS

In the present detailed description, various embodiments of the invention are described mainly with reference to a shower (or shower cabin) comprising a drain system for recovering thermal energy from a flow of greywater

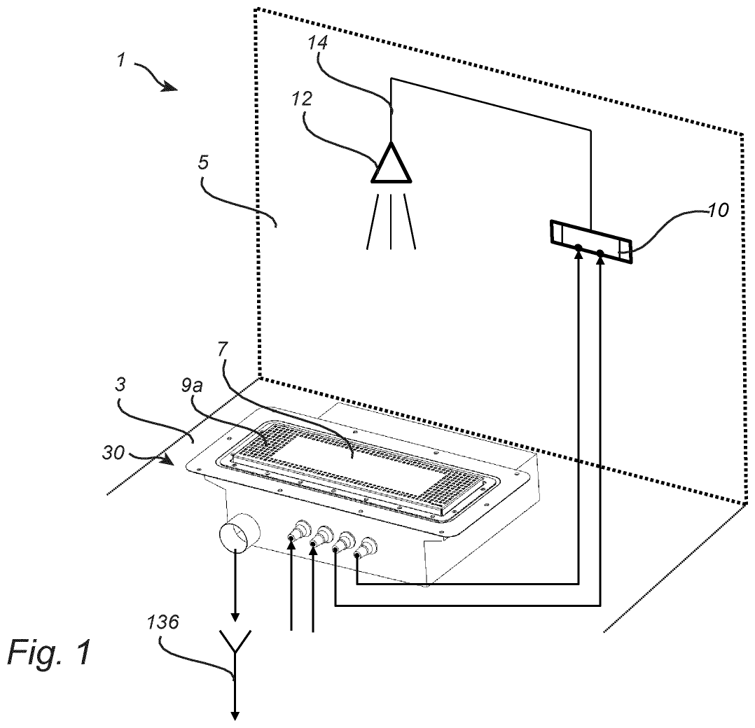

FIG. 1 is a schematic view illustrating a shower or shower cabin 1. The shower or shower cabin 1 comprises a shower tray or shower floor 3, and shower walls 5 (of which only one shower wall is shown). The shower walls 5 are either attached to the building in which the shower 1 is installed, or are separated from the building and thus forming part of a shower cabin 1. Correspondingly, the shower tray or floor 3 is either attached to the building (i.e. constituting a shower floor of a shower), or is separated from the building (i.e. constituting a shower tray of a shower cabin). For simplicity, the shower or shower cabin 1 will in the following be described simply as a shower 1, and the shower tray or floor 3, as a shower floor 3.

The shower 1 further comprises a shower mixer 10 and a shower head 12, the shower head 12 being fluidly connected to the shower mixer 10 by a shower conduit 14, being for example a shower hose or shower pipe. The shower mixer 10 is configured to mix hot water from a hot water supply, e.g. a hot tap water supply, and pre-heated cold water from a cold water supply, the latter being pre-heated cold water from a heat exchanger in the drain system 30 as will be described in the following. During use, the shower mixer 10 mixes the desired amount of pre-heated cold water and hot water, supplies the mixed water to the shower head 12 via the shower conduit 14, whereby shower water for showering is provided. The shower water subsequently encounters the shower floor 3, and enters the shower drain system 30 as greywater. The greywater typically comprises debris, such as textile fibers and hair, as well as grease and shower products, as a result of the showering.

In the embodiment of FIG. 1, the drain system 30 is arranged in a pocket of the shower floor 3, wherein the pocket is covered with a plate 7, and wherein the plate 7 is provided with at least one opening, here being in the form of a plurality of punched holes 9a. However, it should be noted that the at least one opening may instead of a plurality of punched holes 9a be comprised of one or more gaps or slits arranged in the plate 7, for example one or more gaps or slits arranged along one or more of the lateral sides of the plate 7. Thus, the greywater may enter the drain system 30 via the punched holes 9a.

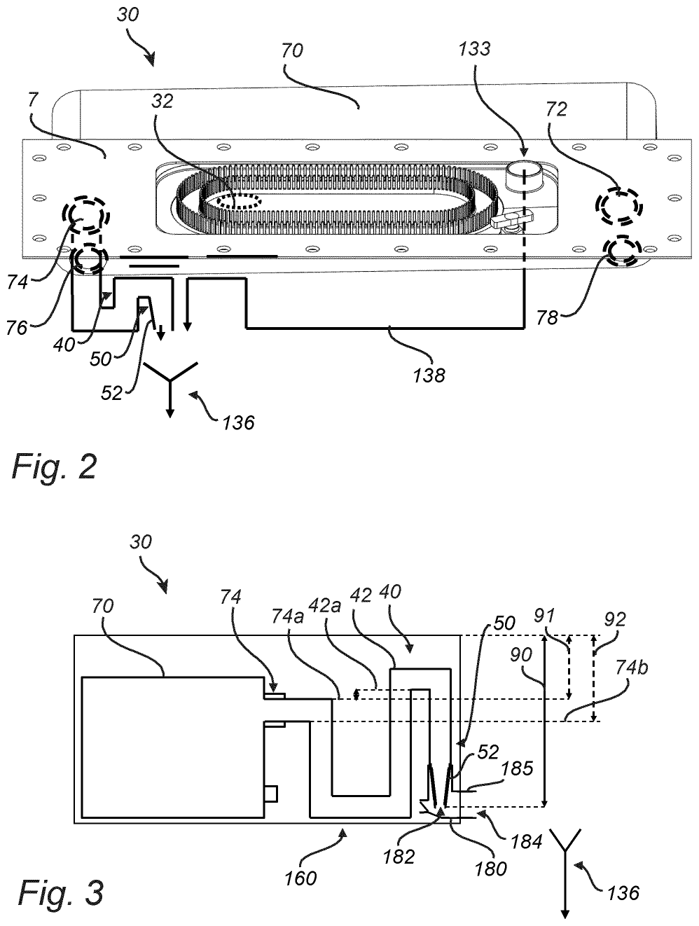

In the following, the drain system 30 will be described in further detail with additional reference to FIG. 2, in which the drain system 30 vertically below the plate 7 is shown in greater detail. The drain system 30 comprises a drain inlet 32 for receiving the greywater, typically after the greywater has passed the punched holes 9a (shown in FIG. 1).

The drain system 30 further comprises a heat exchanger 70 arranged downstream of the drain inlet 32. The heat exchanger 70 comprises a grey water inlet 72 and grey water outlet 74. Moreover, the heat exchanger 70 comprises a cold water inlet 76 for receiving cold water from a cold water supply and a cold water outlet 78 for discharging the pre-heated cold water to the shower mixer 10. The grey water inlet 72, grey water outlet 74, cold water inlet 76 and the cold water outlet 78 are shown in dashed as they partly concealed behind the plate 7. However, it should be noted that the pre-heated cold water may alternatively be supplied to a water heater or instant heater. The heat exchanger 70 is thus configured to heat a flow of incoming cold water with the greywater flowing from the grey water inlet 72 to the grey water outlet 74. In FIG. 2, the heat exchanger 70 is a plate heat exchanger comprising heat exchanging surfaces arranged and configured to transfer heat from the greywater to the incoming cold water.

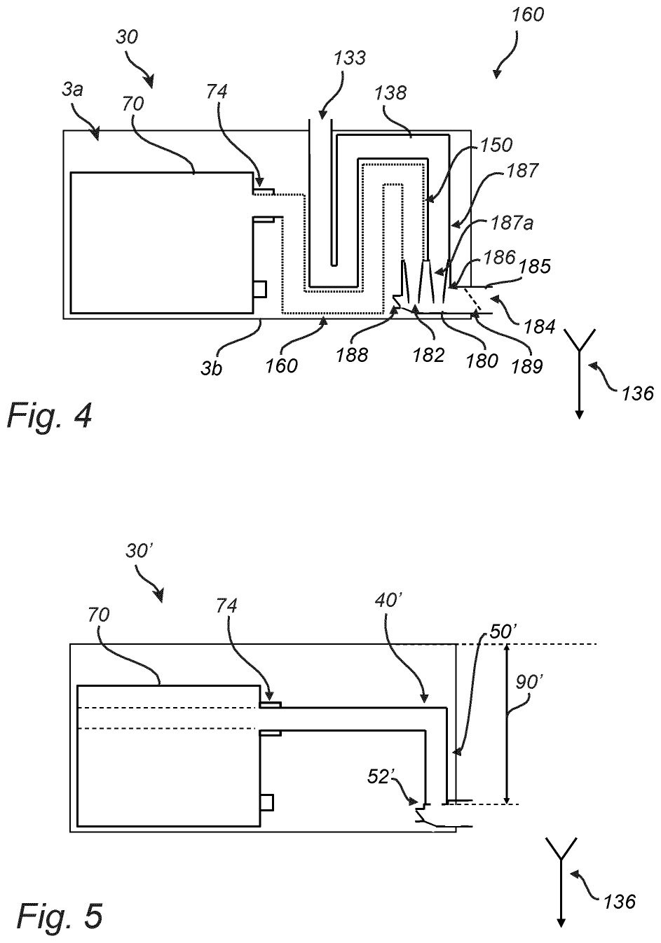

The drain system 30 comprises a water level control pipe portion 40 arranged downstream of the grey water outlet 74. The water level control pipe portion 40 will be described in further detail with reference to FIGS. 3-4.

The drain system 30 comprises a downcomer 50 arranged downstream of the water level control pipe portion 40. The downcomer 50 comprises a contraction 52, schematically illustrated in FIG. 2, for increasing the flowrate of greywater from the grey water inlet 72 to the grey water outlet 74 as will be described in further detail with reference to FIGS. 3-4.

The water level control pipe portion 40 and the downcomer 50 are shown in greater detail in FIG. 3. As shown in FIG. 3, the water level control pipe portion 40 is arranged to control the wetting level of the heat exchanger 70, and to ensure that at least a majority of the heat exchanging surface in the heat exchanger 70 is wetted. In the embodiment of FIG. 3, this is achieved by that the water level control pipe portion 40 has water flow section 42 being a horizontally arranged pipe portion with a lowest point 42a (indicated by a vertical dashed line) arranged vertically above the grey water outlet 74. In the embodiment of FIG. 3, the lowest point 42a of the water flow section 42 is arranged vertically above the highest point 74a of the grey water outlet 74. The difference between the lowest point 42a of the water flow section 42 and The highest point 74a of the grey water outlet 74 is corresponding to the wetting level control of the heat exchanger 70. Preferably, the lowest point 42a of the water flow section 42 is arranged at a higher vertical position as compared to the highest point 74a of the grey water outlet 74. Hereby, a complete, or almost complete, wetting of the heat exchanger is achieved. For example, the vertical distance between the lowest point 42a of the water flow section 42 and the highest point 74a of the grey water outlet 74 is at least 5 mm. Thus, the water level control pipe portion 40 ensures that all heat exchanging surfaces within the heat exchanger 70 and located vertically on the same level or below the grey water outlet 74 are wetted. In other words, the water level control pipe portion 40 acts as a wetting level control portion arranged at a height corresponding to the wetting level of the heat exchanger 70. The water level control pipe portion 40 thus ensures that the wetting level, or water level, within the heat exchanger 70 is kept at the maximum (or rated) level. It should be noted however, that the water flow section 42 may be arranged vertically in the same level as the grey water outlet 74 (shown in FIG. 5). As described above, the water flow section 42 is a horizontally arranged pipe portion. Thus, water level control pipe portion 40 may correspondingly comprise, or constitute, a horizontally arranged pipe portion, or a pipe bend, wherein at least the water flow section 42 is a horizontally arranged pipe portion in the pipe bend.

According to at least one example embodiment, the heat exchanger 70 is arranged to tilt from the greywater inlet 72 to the greywater outlet 74. For example, the greywater outlet 74 is arranged at a lower vertical position as compared to the greywater inlet 72, e.g. correspondingly to a vertical distance of between 5 mm and 50 mm.

Optionally, the radial cross section of the water flow section 42 is non-circular, for example by having an oval form. Thus, the lowest point 42a of the water flow section 42 may be arranged vertically higher compared to if a corresponding circular radial cross section would have been used for the water flow section 42.

The downcomer 50, shown in a cross-sectional view in FIG. 3, is arranged directly downstream of the water level control pipe portion 40. Thus, the water level control pipe portion 40 ends into the downcomer 50. The downcomer 50 is a vertically arranged pipe portion. Thus, the water flow section 42 with the lowest point 42a is separated from the downcomer 50 by a pipe bend. This may e.g. be achieved by that the water level control pipe portion 40 constitutes, or is comprised in, a pipe bend, as previously described.

As shown in the cross sectional view of the downcomer 50, the contraction 52 is tapering in a downstream direction. Hereby, during use, greywater will be guided to the center portion of the downcomer 50, thereby reducing the risk of forming air/gas pockets, or air/gas channels along the internal wall portions of the downcomer 50. For example, the contraction 52 may be conically tapering.

By providing a water level control pipe portion 40 and a downcomer 50 arranged downstream of the grey water outlet 74, a combined effect of controlling the wetting level of the heat exchanger 70 and increasing the flowrate of greywater through the heat exchanger, from the grey water inlet 72 to the grey water outlet 74 is achieved.

Thus, during use, the downcomer 50 results in an increase of the height of the hydraulic pillar, indicated by first vertical arrow 90 as compared to if no downcomer 50 with a contraction 52 would be used (indicated by second vertical arrow 91) and/or as compared to if no water level control pipe portion 40 and no downcomer 50 with a contraction 52 would be used (indicated by third vertical arrow 92 extending from the lowest point 74b of the grey water outlet 74). Hereby, an increased driving pressure of the greywater is achieved, enabling a higher flowrate.

In the embodiment of FIG. 3, the drain system 30 comprises a water trap 160 and a drain manifold 180. The water trap 160 and the drain manifold 180 are physically and functionally independent of each other and will be described separately in the following.

The water trap 160 is arranged downstream of the grey water outlet 74, and is in the example embodiment of FIG. 3 a U-shaped pipe portion, designed to trap liquid or gas to prevent unwanted flow, e.g. sewer gases from flowing upstream in the drain system 30. In FIG. 3, the water trap 160 is arranged upstream of the water level control pipe portion 40.

As seen in FIG. 3, the water trap 160 may extend from a first vertical level below the grey water outlet 74, to a second vertical level being above the first vertical level above the grey water outlet 74. Hereby, at least a part of the water trap 160 may be formed in an S-shape.

The downcomer 50 is typically arranged downstream of the water trap 160. As shown in FIG. 3, the U-shaped water trap 160 may end into the water level control pipe portion 40 as a horizontally arranged pipe portion, and downstream to the downcomer 50 as a vertically arranged pipe portion. Typically, the water level control pipe portion 40 is arranged vertically above the water trap 160.

The drain manifold 180 comprises a first manifold inlet 182 arranged downstream of the downcomer 50, and a manifold outlet 184 arranged to supply any received greywater to a drain outlet 136 (only shown symbolically). As seen in FIG. 3, the downcomer 50 ends in the first manifold inlet 182, and the drain manifold 180 comprises a drain outlet pipe 185 housing the manifold outlet 184. As the drain manifold 180 is arranged in between the downcomer 50 and the drain outlet pipe 185, at least with reference to the fluid flow direction (i.e. the downcomer 50 is arranged upstream the drain manifold 180 and the drain outlet pipe 185 is arranged downstream the drain manifold), the dimensions of the downcomer 50 may differ from that of a drain outlet pipe 185. For example, the diameter of the drain outlet pipe 185 may be larger than that of the downcomer 50. The dimensions (like diameter and/or length) of the drain outlet pipe 185 may e.g. be adapted according to predetermined requirements of the drain system installation, e.g. in order to fulfil applicable standards. The drain manifold 180 also provides an increased stability, or fixity, of the drain system 30, as the downcomer 50 and the drain outlet pipe 185 are fixated in position by the drain manifold 180.

Turning to FIG. 4 showing a more detailed view of the drain system 30 of FIG. 3. In FIG. 4, the water trap 160 and the water level control pipe portion 40 and downcomer 50 are dashed. Again, the drain manifold 180 comprises the first manifold inlet 182 and the manifold outlet 184 as described with reference to FIG. 3. The drain manifold 180 further comprises an optional second manifold inlet 186, and an optional third manifold inlet 188. The drain system 30 further comprises a by-pass conduit 138 (also shown in FIG. 2) connected upstream of the second manifold inlet 186. The by-pass conduit 138 is arranged downstream of an alternative drain inlet 133 (also shown in FIG. 2) and is arranged to supply greywater to the second manifold inlet 186 by by-passing the heat exchanger 70. That is, the drain system 30 may be configured to instead of, or in additional to, guiding greywater via the drain inlet 32 and the heat exchanger 70 further to the drain manifold 180, guide greywater via the alternative drain inlet 133, the by-pass conduit 138 to the drain manifold 180 without passing through the heat exchanger 70. Thus, in case of flooding, or in order to handle a flow of greywater exceeding the capacity of the heat exchanger 70, the drain system 130 is configured to guide the greywater to the drain manifold 180 via the by-pass conduit 138.

The third manifold inlet 188 is arranged to supply greywater leaked from the heat exchanger 70, or any pipe, pipe portions or connections to the heat exchanger 70, to the drain manifold 180. That is, as the drain system 130 may be arranged in a pocket 3a of the shower floor 3 (as shown for drain system 30 in FIG. 1), any leaked greywater ending up in a bottom 3b of the pocket 3a, i.e. outside of the drain system 30, may be re-entered into the drain system 30 via the third manifold inlet 188. It should be noted that the drain manifold 180, and/or the by-pass conduit 138 may comprise an integrated water trap or odor trap. For example, the by-pass conduit 138 may be U-shaped as the previously mentioned water trap 160, and/or an odor trap being a membrane 189 may be installed in the drain manifold 180, such as e.g. at the first, second and/or third manifold inlet 182, 186, 188 or at the manifold outlet 184. In the example embodiment of FIG. 4, the membrane 189 is arranged at the manifold outlet 184, and is arranged to be closed when no greywater flows through the manifold outlet 184 to thereby prevent odors upstream in the drain system 30, and is arranged to open (e.g. by pivoting) upon receiving a greywater flow through the manifold outlet 184.

Moreover, as seen in FIG. 4, the connection to the second manifold inlet 186, or the manifold inlet 186 itself, may comprise a downcomer 187. Thus, the downcomer 150 arranged upstream of the first manifold inlet 182 may be referred to as a first downcomer 150, and the downcomer 187 associated with the second manifold inlet 186 may be referred to as a second downcomer 187. The second downcomer 187 may e.g. be arranged in the by-pass conduit 138 shown in FIG. 4. Hereby, the flowrate of greywater in the by-pass conduit 138 may be increased in a corresponding manner as described with reference to the first downcomer 150. The second downcomer 187 comprises a contraction 187a for increasing and stabilizing the flowrate of greywater and is preferably a vertically arranged pipe portion, and/or the contraction is a tapering contraction (typically a tapering contraction in the downstream direction, and/or is conically tapering).

Turning to FIG. 5, showing an alternative drain system 30′, comprising a corresponding water level control portion 40′ and downcomer 50′ as in the drain system 30 of FIG. 3, why only the differences between the drain systems 30, 30′ are described here. The same reference numerals as in FIGS. 3-4 are used for like features in FIG. 5, such as e.g. the heat exchanger 70 and the grey water outlet 74. However, in the embodiment of FIG. 4, the drain system 30′ does not comprise a U-shaped water trap 160 as for the drain system 30 of FIG. 3. Instead, the water level control portion 40′ is arranged as an extension of the grey water outlet 74, and is thus arranged in the same vertical level as the grey water outlet 74. Furthermore, the downcomer 50′ comprises a contraction 52′ which is arranged as a throttle flange 52′ inside the downcomer 50′. As shown by the vertical arrow 90′, the height of the hydraulic pillar can still be kept as a satisfactory level.

Even though the invention has been described with reference to specific exemplifying embodiments thereof, many different alterations, modifications and the like will become apparent for those skilled in the art. For example, the drain system may be installed for heat recovery of greywater from a faucet, or a bathtub, instead of a shower.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A drain system for recovering thermal energy from a flow of shower or faucet greywater, the drain system comprising:
a drain inlet for receiving greywater,
a plate heat exchanger arranged downstream of the drain inlet and comprising a grey water inlet and grey water outlet, the heat exchanger being configured to heat a flow of incoming cold water with the greywater flowing from the grey water inlet to the grey water outlet,
a water level control pipe portion arranged downstream of the grey water outlet, the water level control pipe portion being configured to control the wetting level of the plate heat exchanger, wherein
the drain system further comprises a downcomer arranged downstream of the water level control pipe portion and comprising a contraction for increasing the flowrate of greywater from the grey water inlet to the grey water outlet.

2. A drain system for recovering thermal energy from a flow of shower or faucet greywater, the drain system comprising:
a drain inlet for receiving greywater,
a heat exchanger arranged downstream of the drain inlet and comprising a grey water inlet and grey water outlet, the heat exchanger being configured to heat a flow of incoming cold water with the greywater flowing from the grey water inlet to the grey water outlet,
a water level control pipe portion arranged downstream of the grey water outlet, wherein
the drain system further comprises a downcomer arranged downstream of the water level control pipe portion and comprising a contraction for increasing the flowrate of greywater from the grey water inlet to the grey water outlet.

3. The drain system according to claim 1, wherein the water level control pipe portion has a water flow section with a lowest point arranged vertically above at least a portion of the grey water outlet.

4. The drain system according to claim 1, further comprises a water trap arranged downstream of the grey water outlet, and wherein the water level control pipe portion is comprised in the water trap or is arranged downstream of the water trap.

5. The drain system according to claim 1, wherein the water level control pipe portion is a horizontally arranged pipe portion, or is comprised in a pipe bend.

6. The drain system according to claim 1, wherein the downcomer is a vertically arranged pipe portion.

7. The drain system according to claim 1, wherein the contraction is tapering in a downstream direction.

8. The drain system according to claim 1, further comprising a drain manifold having a first manifold inlet arranged downstream of the downcomer, and a manifold outlet arranged to supply any received grey water to a drain outlet.

9. The drain system according to claim 8, wherein the downcomer ends in the first manifold inlet.

10. The drain system according to claim 8, wherein the drain manifold comprises a second manifold inlet, and the drain system further comprises a by-pass conduit arranged to supply greywater to the second manifold inlet by by-passing the heat exchanger.

11. The drain system according to claim 10, wherein the downcomer is a first downcomer, and the drain system comprises a second downcomer arranged in the by-pass conduit and comprising a contraction for increasing the flowrate of greywater in the by-pass conduit.

12. The drain system according to claim 2, when being dependent on claim 2, wherein the heat exchanger is a plate heat exchanger.

13. The drain system according to claim 1, wherein the radial cross section of the water level control pipe portion is non-circular.

14. The drain system according to claim 4, wherein the water trap is a U-shaped pipe portion or an S-shaped pipe portion.

15. A shower or shower cabin comprising:
a shower arrangement having a shower mixer configured to mix hot water from a hot water supply and pre-heated cold water from a cold water supply, and a shower head fluidly connected to the shower mixer for supplying shower water;
a drain system according to claim 1.
